(19) United States
(12) Patent Application Publication
(10) Pub. No.: US 2024/0240753 A1
(43) Pub. Date: Jul. 18, 2024

(54) METHOD FOR APPLYING INSULATION TO A COMBINED CYLINDRICAL TANK, A COMBINED CYLINDRICAL TANK AND USE THEREOF

(71) Applicant: LNT MARINE PTE., LTD., Singapore (SG)

(72) Inventor: Per Ivar Nikolaisen, Tønsberg (NO)

(21) Appl. No.: 18/015,177

(22) PCT Filed: Jun. 24, 2021
(86) PCT No.: PCT/IB21/55604

§ 371 Date: Jan. 9, 2023

(30) Foreign Application Priority Data
Jul. 9, 2020 (NO) 20200801

(51) Int. Cl. F17C 3/04; F17C 3/02

(52) U.S. Cl. CPC F17C 3/04; F17C 3/025; F17C 2201/0104; F17C 2203/0333; F17C 2203/0624; F17C 2203/0636; F17C 2203/066; F17C 2209/225; F17C 2209/228; F17C 2221/033; F17C 2221/035; F17C 2223/0161; F17C 2260/033; F17C 2270/0105

(57) ABSTRACT

The present invention concerns a method for applying insulation to a combined cylindrical tank for storage of liquefied gas. One or more layers of a polymer foam (2) are sprayed onto the exterior surface of the tank shell (1). Crack barriers (4) are mounted on top of certain layers of the polymer foam (2), wherein the crack barriers (4) are anchored to the exterior surface of the tank shell (1). The invention also concerns a corresponding combined cylindrical tank for storage of liquefied gas, as well as the use of such a combined cylindrical tank for storing and/or transporting a liquefied gas.

### FIELD OF THE INVENTION

The present invention is concerned with tanks for storage and transportation of liquefied gases, such as utilized in marine installations. Specifically, the invention is concerned with a novel method for applying insulation to combined cylindrical tanks.

### BACKGROUND OF THE INVENTION

Liquefied gases are normally stored at low to very low temperatures, close to their boiling point, to avoid high pressures during storage. Consequently, there is a need for storage tanks with advanced thermal insulation to keep the gas contained therein cold and liquid. Common tank types to store liquefied gases are cylindrically shaped tanks comprising a single cylindrical section, or lobe, such as International Maritime Organization (IMO) independent type C tanks. These single-lobe cylindrical tanks comply with the IMO International Code for the Construction and Equipment of Ships Carrying Liquefied Gases in Bulk (IGC Code).

A cylindrical tank is, due to its form, particularly suitable for withstanding pressurized conditions, as the cylindrical form creates few stress concentrations in the tank structure. Consequently, with increasing pressure stress peaks will be more controllable for a cylindrical tank than for a tank type with a transversal cross-section including sharper corners.

On the other hand, a single-lobe cylindrical tank will normally give a poor volume utilization in the tank space, or hold space, in which the tank is placed. This aspect is particularly important for marine installations, which typically have hold spaces with rectangularly shaped transverse cross-sections.

For rectangularly shaped hold spaces, one solution is therefore to combine two or more cylindrical tank sections. Combined cylindrical tanks therefore include two or more cylindrical tank sections, connected along their longitudinal direction, for instance by welding. This solution increases the volume utilization in a hold space with a rectangularly shaped cross-section, as compared to a single cylindrical tank.

The most common types of combined cylindrical tanks are bi-lobe type tanks. The transverse cross-section of a bi-lobe tank includes two connected cylindrical sections and typically has a binocular type form, with a strength bulkhead connecting the two cylindrical tank sections. The strength bulkhead may be welded to the two cylindrical sections along the longitudinal direction thereof. A bi-lobe tank provides a higher volume utilization than a single-lobe cylindrical tank when placed in a rectangular hold space volume. At the same time, the strength wise benefits of the cylindrical shape are mostly maintained.

Alternatively, three or more cylindrical sections may be connected, for instance by welding, in the same manner as for bi-lobe type tanks. Connecting strength bulkheads are placed between each two neighboring cylindrical sections and may also be used for the storage of liquefied gasses. Tri-lobe tanks include three connected cylindrical sections in their transversal cross-section, whereas multi-lobe tanks include more than three connected cylindrical sections in their transversal cross-section.

For thermal insulation purposes, it is well known to directly apply a polymer foam, such as polyurethane (PU) foam, to the exterior surface of the tank, by spraying. The polymer foam usually comprises two main components, i.e. a premixed polyol and an isocyanate (P-MDI) in case of a PU foam. During application, the main components are mixed to form a polymer foam precursor, which is then dispensed from a spray gun and sprayed onto the tank shell exterior. Upon application the polymer spray foam expands and subsequently cures, forming an insulation layer. The polymer spray foam is usually applied in several layers of 10 to 35 mm thickness onto the tank shell exterior, to obtain the required total insulation layer thickness.

Application of polymer spray foam by spraying directly onto the tank shell exterior is mostly used on single-lobe cylindrical tanks. Once applied to the tank, the polymer spray foam is only kept in position on the tank shell exterior surface through the adhesion between the polymer spray foam and the tank shell exterior surface. This adhesion is created during the curing of the polymer foam on the tank. Consequently, the adhesive strength is limited to the tensile strength in the foam.

In contrast to single-lobe tanks, combined cylindrical tanks of the bi-lobe, tri-lobe or multi-lobe type, present challenges for secure adhesion of polymer spray foam insulation. The transversal cross-sectional geometry of these combined cylindrical tanks in the connection area between the separate cylindrical tank sections is complicated. Consequently, a high concentration of thermal stress occurs in the polymer spray foam insulation in the connection area(s) during temperature changes of the tank. Issues arise due to thermal contractions and stress in the multi-directional surfaces at the joint sections between the strength bulkheads and separate cylindrical tank sections. These stresses occur during cooling down and warming up of the tank and increase the risk of delamination between the spray foam and the tank shell exterior surface. Specifically, the thermal shrinkage of the tank material is different from the thermal shrinkage of the foam insulation material. In addition, the foam material experiences a different shrinkage throughout its thickness due to the temperature gradient from its cold side, near the tank shell, to its warm side, on its outer surface. The combination of these geometry-induced differences in thermal shrinkage causes multi-directional stress within the foam which may result in delamination between the foam and the tank shell surface. The colder the liquefied gas contained in the tank is, the more pronounced these effects become, given the higher temperature gradients involved.

Due to these issues, it has been standard practice to use mechanically fixed insulation panels, instead of spray foam, for combined cylindrical tanks of the bi-lobe, tri-lobe or multi-lobe type. Mechanically fixed insulation panels are, however, time-consuming and costly to manufacture. Moreover, mechanically fixed panels are labor-intensive and therefore costly to apply.

Consequently, there is a clear need for an improved insulation arrangement for combined cylindrical tanks, as well as an improved method of applying insulation to combined cylindrical tanks.

WO 2020050515 A1 discloses a plurality of sandwich panels including a first heat insulating panel and a second heat insulating panel fixed to the wall structure of a tank. WO 2018029613 A1 discloses a cryogenic insulation system for ocean going vessels, involving the steps of sequentially applying a plurality of layers to the outer surface of a tank. US 2017101163 A1 discloses a marine vessel cryogenic barrier formed of a plurality of individual panels.

### BRIEF SUMMARY OF THE INVENTION

The present invention concerns a method for applying insulation to a combined cylindrical tank for storage of liquefied gas. The method comprises providing a combined cylindrical tank comprising a tank shell, spraying one or more layers of a polymer foam onto the exterior surface of the tank shell and mounting crack barriers on top of certain layers of polymer foam, wherein the crack barriers are anchored to the exterior surface of the tank shell.

The present invention also concerns a combined cylindrical tank for storage of liquefied gas. The combined cylindrical tank comprises a tank shell and one or more layers of a polymer spray foam covering the exterior surface of the tank shell, one or more crack barriers, mounted on top of certain layers of polymer spray foam and anchored to the exterior surface of the tank shell.

Finally, the present invention also concerns the use of a combined cylindrical tank according to the invention, for storing and/or transporting a liquefied gas, such as a liquefied natural gas, a liquefied petroleum gas, a liquefied ethane gas or a liquefied ethylene gas.

The method for applying insulation to a combined cylindrical tank and corresponding insulated combined cylindrical tank according to the present invention are applicable to the field of storage and transportation of liquified gases, such as liquefied petroleum gas (LPG), liquified ethane and/or ethylene gas, liquefied natural gas (LNG) or other cryogenic liquefied gases.

### BRIEF DESCRIPTION OF THE DRAWINGS

FIG. 1 is a schematic transverse section of a connection area of a combined cylindrical tank including a stud for anchoring foam insulation as described herein.

FIG. 2a is a schematic cross-section of a stud configuration according to a first configuration.

FIG. 2b is a schematic cross-section of a stud configuration according to an alternative configuration.

FIG. 2c is a schematic cross-section of a stud configuration according to a further alternative configuration.

### DETAILED DESCRIPTION OF THE INVENTION

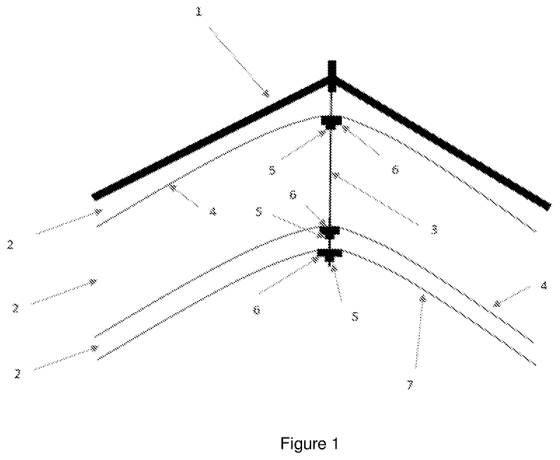

FIG. 1 schematically shows a transverse cross-sectional view of a part of a tank shell 1 in a connection area of a combined cylindrical tank. The combined cylindrical tank is suitable for transport and storage of liquefied gases, preferably being an IMO independent type C tank. The combined cylindrical tank may be a bi-lobe, tri-lobe, or multi-lobe type tank. In each case, transversally adjacent cylindrical sections are connected by a strength bulkhead positioned therebetween. The strength bulkheads may be welded to the adjacent cylindrical sections in the longitudinal direction thereof.

One or more layers of polymer spray foam 2 adhere to the exterior of the tank shell 1, forming insulation on the tank shell 1 wherein each layer of polymer spray foam 2 may consist of several sub layers. Preferably, the polymer spray foam 2 comprises a polyurethane (PU) foam. The polymer spray foam 2 may optionally comprise additives, such as strengthening fibers, intumescent additives, anti-microbial or anti-fungal agents, or volumetric fillers.

Studs 3 extend from the connection area of the cylindrical sections of the combined cylindrical tank. Preferably, the studs 3 extend locally in the normal direction to the tank shell surface. The studs 3 are preferably provided with screw threads. Preferably, the studs 3 are welded to the tank shell 1.

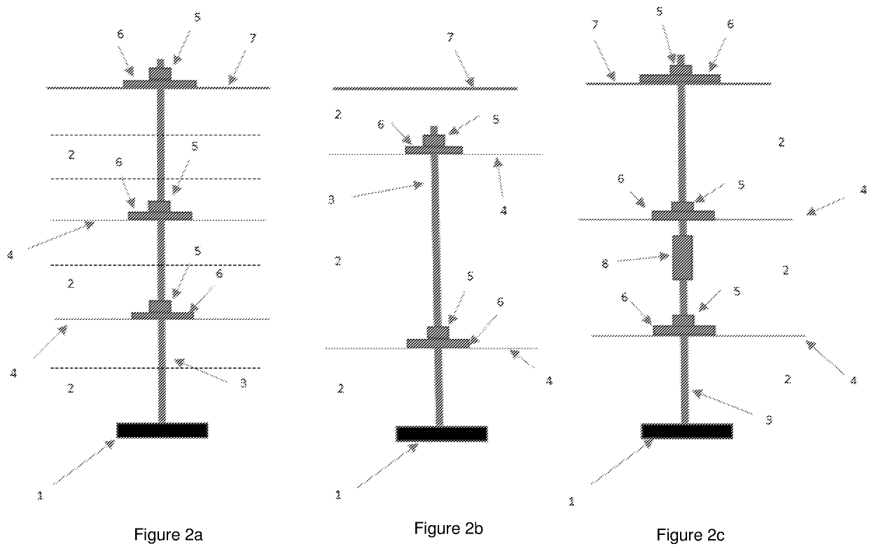

One or more crack barriers 4 are connected to the studs 3 and extend laterally along certain layers of polymer spray foam 2. The crack barriers 4 may be in the form of a mesh or a perforated thin plate. The crack barriers 4 may comprise a plastics material, a glass fiber material, a metal, or a composite material. The crack barriers 4 may be placed equidistantly along the studs 3. Alternatively, the crack barriers 4 may be placed along the studs 3 at intervals of varying length, see FIG. 1. In the latter case, there may be different numbers of layers of polymer spray foam between different pairs of crack barriers. Alternatively, each layer of polymer spray foam 2 may comprise a different number of sublayers and thereby achieve a different thickness. Sublayers are indicated with striped lines in FIG. 2a, where same reference signs denote the same features. FIG. 2a schematically shows a transverse cross-sectional view of a tank shell 1, polymer spray foam layers 2 and cladding 7.

Securing bars 6, washers and nuts 5 secure the one or more crack barriers 4 in position on the studs 3. The securing bars 6 may be made from a sufficiently strong material, such as a metal, reinforced plastics, plywood, a composite material, or any other suitable strength bearing material. Advantageously, the securing bars 6 are configured such that securing forces are effectively transferred from the stud bolts 3 to the crack barriers 4.

Each crack barrier 4 locally fixes the underlying layer(s) of polymer spray foam 2 to the tank shell. Therefore, moving from the tank shell outwards along a stud 3, each one or more layer(s) of polymer spray foam 2 is (are) locally secured in place by a crack barrier 4. Thereby, the crack barriers 4 and securing bars 6 secure the polymer spray foam layers to the tank, preventing the polymer spray foam 2 from loosening from the tank shell surface and preventing insulation delamination.

During application, first one or more layers of polymer spray foam 2 are applied onto the exterior of the tank shell 1, where each layer of polymer spray foam 2 may comprise one or more sublayers. Application of the one or more layers of polymer spray foam 2 is followed by the mounting of a crack barrier 4. The process is then repeated until the desired number of layers of polymer spray foam 2 is achieved. Each layer of polymer spray foam 2 applied directly on top of a crack barrier 4 is mechanically and chemically anchored to said crack barrier 4 and to the layers of polymer spray foam 2 below.

Mechanical anchoring occurs due to expansion of the overlying foam layer into the gaps of the mesh or perforated plate forming the crack barrier 4. Chemical anchoring occurs due to the bonding of the overlying foam layer to the underlying foam layer, situated below the crack barrier 4, through the gaps in the crack barrier 4. Consequently, each crack barrier 4 situated between layers of polymer spray foam 2 is firmly embedded in the polymer spray foam 2.

A mechanical protection material covers the exterior of the polymer spray foam 2, thereby forming the outer surface of the tank and a barrier to the surrounding environment. The mechanical protection material is preferably a cladding 7, preferably comprising a metal material. Preferably, the cladding 7 is configured to be watertight. The cladding 7 may be fixed in place on studs 3 by securing bars 6, washers and nuts 5, see FIG. 1.

Advantageously, the crack barriers keep the layers of polymer spray foam in place and prevent the occurrence of delamination due to thermally induced stresses in the foam. Additionally, the crack barriers advantageously take some of the weight off the cladding.

Alternative configurations are shown in FIGS. 2b and 2c, where the same reference signs denote the same features as in FIGS. 1 and 2a. For the sake of legibility, sublayers are not indicated in FIGS. 2b and 2c. According to one alternative configuration, shown in FIG. 2b, the cladding 7 is not secured to the stud 3. Advantageously a thermal break between the stud and the outer surface, formed by the cladding, is thereby created. Thereby thermally induced stresses are reduced, further reducing the risk of delamination of the insulation.

According to another alternative configuration, shown in FIG. 2c, a thermal break element 8 is formed as an integral part of the stud 3. The thermal break element 8 is preferably positioned between two crack barriers 4. Advantageously, the thermal break element divides the stud in two parts, thereby creating a thermal break in the stud itself and reducing thermally induced stresses. Consequently, the risk of delamination of the insulation is further reduced.

A method for applying insulation to a combined cylindrical tank according to the invention is described next.

A combined cylindrical tank as described previously in connection with FIG. 1, is provided. The combined cylindrical tank includes a tank shell 1, provided with studs 3. The studs 3 are located along the longitudinal connection area(s) between the cylindrical tank sections. One or more crack barriers 4 may be attached to the studs 3, by means of securing bars 6, washers and nuts 5, as shown in FIG. 1.

Polymer spray foam 2 is sprayed onto the exterior surface of the tank shell 1 in separate layers. A polymer foam precursor is dispensed from a spray gun, which may be a manually operated or a robotically operated spray gun. Each passing of the spray gun forms a sublayer of polymer spray foam 2. One or more sublayers form a layer of polymer spray foam 2. Upon application to the tank shell 1, the polymer foam precursor expands and adheres to the exterior surface of the tank shell 1. Optionally, the polymer spray foam 2 may be cured upon expansion. Crack barriers 4 are then mounted on studs 3 to locally cover the layer of polymer spray foam 2. Mounting of the crack barriers 4 is followed by the application of a subsequent layer of polymer spray foam 2, onto which further crack barriers 4 are applied. The subsequent layers of polymer spray foam 2 adhere to the underlying layer(s) of polymer spray foam 2. The process continues until the desired number of layers of polymer spray foam is achieved. To the outermost layer of polymer spray foam layer 2 crack barriers 4 may or may not be applied. Once completed, the sprayed-on, expanded and possibly cured polymer spray foam 2 forms an insulation layer surrounding the tank shell 1.

During spraying and expansion of each subsequent layer of polymer spray foam 2, the polymer foam precursor penetrates and expands through the gaps in the mesh or perforated plate forming a crack barrier 4. Consequently, each subsequent foam layer is mechanically anchored into the crack barriers 4 onto which it is applied. Additionally, the polymer foam precursor bonds chemically during expansion through the gaps in the crack barriers 4 to the previous layer of polymer spray foam. By mechanical and chemical anchoring, the polymer spray foam 2 becomes securely attached to the crack barriers 4, thereby preventing delamination due to thermal stresses in the foam.

Upon completion of application of the polymer spray foam 2, a mechanical protection material, such as a cladding 7 as described above in connection with FIG. 1, may be provided, to cover the polymer spray foam insulation. The cladding 7 may be attached directly to the studs 3, as shown in FIG. 2a. Optionally, the studs 3 may be provided with a thermal break element 8, as shown in the alternative configuration of FIG. 2c.

Alternatively, the cladding may remain not secured to the studs 3, thereby forming a thermal break, as shown in the alternative configuration of FIG. 2b.

Advantageously, the method of the present invention provides the convenience and associated reduced labor efforts and costs of a polymer spray foam tank insulation process, while simultaneously preventing the risk of delamination of insulation usually associated with spray foam insulation on combined cylindrical tanks.

In use, the combined cylindrical tank according to the invention can be utilized for the storing and/or transport of a liquefied gas. Thereto, the combined cylindrical tank may be mounted in the hold space of a marine structure, such as an LNG or LPG carrier.

The coldest liquefied gas stored in combined cylindrical tanks is currently LNG. Advantageously, the present invention allows using combined cylindrical tanks insulated with polymer spray foam insulation for LNG and for even colder liquified gases, while delamination problems are securely prevented.

The foregoing embodiments and examples are by no means limiting, the scope of the invention being solely defined by the appended claims.

### REFERENCE SIGNS

1 tank shell
2 polymer spray foam
3 stud
4 crack barrier
5 washer and nut
6 securing bar
7 cladding
8 thermal break element

1-20. (canceled)

21. A method for applying insulation to a combined cylindrical tank of bi-lobe, tri-lobe or multi-lobe type for storage of liquefied gas, the method comprising:
providing a combined cylindrical tank of bi-lobe, tri-lobe or multi-lobe type comprising a tank shell (1);
spraying one or more layers of a polymer foam (2) onto the exterior surface of the tank shell (1); and
mounting one or more crack barriers (4) on top of one or more layers of polymer foam (2), wherein the one or more crack barriers (4) are anchored to the exterior surface of the tank shell (1) in connection area(s) of cylindrical sections of the combined cylindrical tank of bi-lobe, tri-lobe or multi-lobe type.

22. The method according to claim 21, wherein the one or more crack barriers (4) are anchored to the exterior surface of the tank shell (1) by means of studs (3), fixed to the tank shell (1).

23. The method according to claim 22, wherein the one or more crack barriers (4) are fixed in place on the studs (3) by securing bars (6), washers and nuts (5).

24. The method according to claim 21, wherein each crack barrier (4) comprises a mesh or perforated plate.

25. The method according to claim 24, wherein the mesh or perforated plate comprises a plastic material, a glass fiber material, a metal or a composite material.

26. The method according to claim 22, wherein, after completion of spraying, a cladding (7) is attached to the combined cylindrical tank.

27. The method according to claim 26, wherein the cladding (7) is fixed to the studs (3) by means of securing bars (6), washers and nuts (5).

28. The method according to claim 27, wherein each stud (3) comprises a thermal break, forming an integral part of the stud (3).

29. The method according to claim 26, wherein the cladding (7) remains unconnected to the studs (3), thereby creating a thermal break.

30. A combined cylindrical tank of bi-lobe, tri-lobe or multi-lobe type for storage of liquefied gas, the combined cylindrical tank of bi-lobe, tri-lobe or multi-lobe type comprising:
a tank shell (1);
one or more layers of a polymer spray foam (2) covering the exterior surface of the tank shell (1);
one or more crack barriers (4), mounted on top of one or more layers of polymer spray foam (2) and anchored to the exterior surface of the tank shell (1) in connection area(s) of cylindrical sections of the combined cylindrical tank of bi-lobe, tri-lobe or multi-lobe type.

31. The combined cylindrical tank according to claim 30, wherein the one or more crack barriers (4) are anchored to the exterior surface of the tank shell (1) by means of studs (3), fixed to the tank shell (1).

32. The combined cylindrical tank according to claim 31, wherein the one or more crack barriers (4) are fixed in place on the studs (3) by securing bars (6), washers and nuts (5).

33. The combined cylindrical tank according to claim 30, wherein each crack barrier (4) comprises a mesh or perforated plate.

34. The combined cylindrical tank according to claim 33, wherein the mesh or perforated plate comprises a plastic material, a glass fiber material, a metal, or a composite material.

35. The combined cylindrical tank according to claim 31, further comprising a cladding (7), covering the polymer spray foam (2).

36. The combined cylindrical tank according to claim 35, wherein the cladding (7) is fixed to the studs (3) by means of securing bars (6), washers and nuts (5).

37. The combined cylindrical tank according to claim 36, wherein each stud (3) comprises a thermal break, forming an integral part of the stud (3).

38. The combined cylindrical tank according to claim 35, wherein the cladding (7) is unconnected to the studs (3), thereby creating a thermal break.

39. Marine installation, such as a vessel, comprising a combined cylindrical tank according to claim 30.

40. Use of a combined cylindrical tank according to claim 30 for storing and/or transporting a liquefied gas, such as a liquefied natural gas, a liquefied petroleum gas, a liquefied ethane gas or a liquefied ethylene gas.
